(19) United States
(12) Patent Application Publication
(10) Pub. No.: US 2026/0086704 A1
(43) Pub. Date: Mar. 26, 2026

(54) ELECTRONIC DEVICE SUPPORTING MULTI-WINDOW, AND CONTROL METHOD THEREOF

(71) Applicant: Samsung Electronics Co., Ltd., Suwon-si (KR)

(72) Inventors: Wanje PARK, Suwon-si (KR); Haeree NA, Suwon-si (KR); Heekyung MOON, Suwon-si (KR); Jinwan AN, Suwon-si (KR); Junhee CHO, Suwon-si (KR)

(21) Appl. No.: 19/410,091

(22) Filed: Dec. 5, 2025

Related U.S. Application Data
(63) Continuation of application No. PCT/KR2024/007799, filed on Jun. 7, 2024.

(30) Foreign Application Priority Data
Jun. 7, 2023 (KR) 10-2023-0072782
Jul. 17, 2023 (KR) 10-2023-0092329

(51) Int. Cl. G06F 3/04847; G06F 3/0488; G06T 11/20

(52) U.S. Cl. CPC G06F 3/04847; G06F 3/0488; G06T 11/23; G06T 2200/24; G06T 2210/62

(57) ABSTRACT

An electronic device may include: a touch screen, and at least one processor, comprising processing circuitry, memory storing instructions that, when executed by at least one processor individually or collectively, cause the electronic device to: display, through the touch screen, a first window of a lower layer, and a second window of an upper layer, the second window at least partially overlapping the first window, receive an input through a first area of the first window that does not overlap the second window, and increase the transparency of the second window based on sensing that the input continuously moves from the first area to a second area in which the first window is overlapped with the second window.

### CROSS-REFERENCE TO RELATED APPLICATIONS

This application is a continuation of International Application No. PCT/KR2024/007799 designating the United States, filed on Jun. 7, 2024, in the Korean Intellectual Property Receiving Office and claiming priority to Korean Patent Application Nos. 10-2023-0072782, filed on Jun. 7, 2023, and 10-2023-0092329, filed on Jul. 17, 2023, in the Korean Intellectual Property Office, the disclosures of each of which are incorporated by reference herein in their entireties.

### BACKGROUND

### Field

The disclosure relates to an electronic device supporting multiple windows and a control method thereof.

### Description of Related Art

Various services and additional functions provided through electronic devices, for example, portable electronic devices such as smartphones, are steadily increasing. In order to enhance the utility value of such electronic devices and meet the diverse needs of users, telecommunications service providers and electronic device manufacturers are competitively developing electronic devices offering diverse functions and differentiating themselves from competitors. Accordingly, the various functions provided through electronic devices are also becoming increasingly sophisticated.

In addition, electronic devices provide various graphical user interfaces (GUIs) to facilitate user interaction through displays.

As electronic devices become capable of executing multiple applications, technologies that support interaction between running applications are becoming important.

Accordingly, electronic devices support muti-window functionality, when multiple applications are executed, to simultaneously display execution screens of the multiple applications through split screens or pop-ups.

### SUMMARY

According to an example embodiment, an electronic device may include a touch screen, at least one processor, comprising processing circuitry, and memory storing instructions.

According to an example embodiment, instructions that, when executed by at least one processor individually or collectively, may cause the electronic device to display, through the touch screen, a first window of a lower layer and a second window of an upper layer at least partially overlapping the first window.

According to an example embodiment, instructions that, when executed by at least one processor individually or collectively, may cause the electronic device to receive an input through a first area of the first window that does not overlap the second window.

According to an example embodiment, instructions that, when executed by at least one processor individually or collectively, may cause the electronic device to increase, based on detecting that the input continuously moves from the first area to a second area where the first window is overlapped with the second window, the transparency of the second window.

According to an example embodiment, a method of controlling an electronic device may include displaying, through a touch screen of the electronic device, a first window of a lower layer and a second window of an upper layer at least partially overlapping the first window.

According to an example embodiment, the method of controlling an electronic device may include receiving an input through a first area of the first window that does not overlap the second window.

According to an example embodiment, the method of controlling an electronic device may include increasing, based on detecting that the input continuously moves from the first area to a second area where the first window is overlapped with the second window, the transparency of the second window.

According to an example embodiment, a non-transitory computer-readable recording medium may store one or more programs, and the one or more programs may include instructions which, when executed by at least one processor, comprising processing circuitry, of the electronic device, individually and/or collectively, cause the electronic device to display, through the touch screen, a first window of a lower layer and a second window of an upper layer at least partially overlapping the first window.

According to an example embodiment, the one or more programs may include instructions which, when executed by at least one processor, comprising processing circuitry, of the electronic device, individually and/or collectively, cause the electronic device to receive an input through a first area of the first window that does not overlap the second window.

According to an example embodiment, the one or more programs may include instructions which, when executed by at least one processor, comprising processing circuitry, of the electronic device, individually and/or collectively, cause the electronic device to increase, based on detecting that the input continuously moves from the first area to a second area where the first window is overlapped with the second window, the transparency of the second window.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments.

FIG. 2 is a diagram illustrating an example operation of an electronic device in an upper window in response to input on a lower window in a multi-window state according to various embodiments.

FIG. 3 is a flowchart illustrating an example operation of an electronic device in an upper window in response to input on a lower window in a multi-window state according to various embodiments.

FIG. 4 is a diagram illustrating an example operation of an electronic device for adjusting the transparency of an upper window in response to input on a lower window in a multi-window state according to various embodiments.

FIG. 5 is a diagram illustrating an example operation of an electronic device for overlaying an upper window in response to input on a lower window in a multi-window state according to various embodiments.

FIG. 6 is a diagram illustrating an example operation of an electronic device for adjusting the transparency of an upper window depending on the amount of content on the upper window in a multi-window state according to various embodiments.

FIG. 7 is a diagram illustrating an example operation of an electronic device for adjusting the transparency of an upper window depending on the color of content on the upper window in a multi-window state according to various embodiments.

FIG. 8 is a diagram illustrating an example operation of an electronic device for adjusting the transparency of an upper window according to a handwriting operation in a multi-window state according to various embodiments.

FIG. 9 is a diagram illustrating an example operation of an electronic device for adjusting the transparency of an upper window according to a text input operation in a multi-window state according to various embodiments.

FIG. 10 is a diagram illustrating an example operation of an electronic device after input is terminated in a multi-window state according to various embodiments.

FIG. 11 is a diagram illustrating an example operation of an electronic device for adjusting the transparency of two upper windows in a multi-window state including three or more windows according to various embodiments.

FIG. 12 is a diagram illustrating an example operation of an electronic device for moving an upper window in response to input on a lower window in a multi-window state according to various embodiments.

FIG. 13 is a diagram illustrating an example operation of an electronic device for moving an upper window depending on the location of the upper window in a multi-window state according to various embodiments.

FIG. 14A is a diagram illustrating an example operation of an electronic device for moving an upper window depending on the location of content included in a lower window in a multi-window state according to various embodiments.

FIG. 14B is a diagram illustrating an example operation of an electronic device for moving an upper window depending on the location of content included in a lower window and the input location in a multi-window state according to various embodiments.

### DETAILED DESCRIPTION

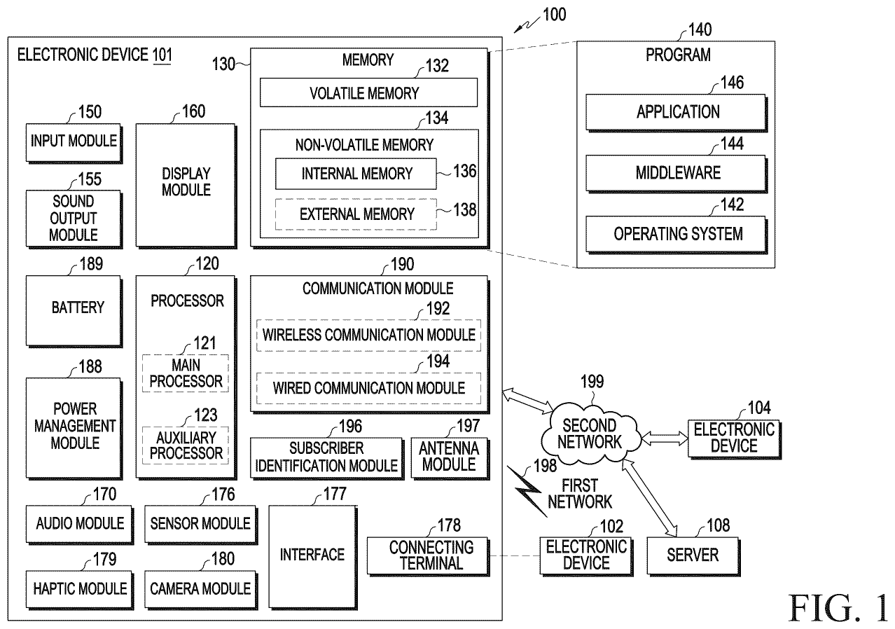

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

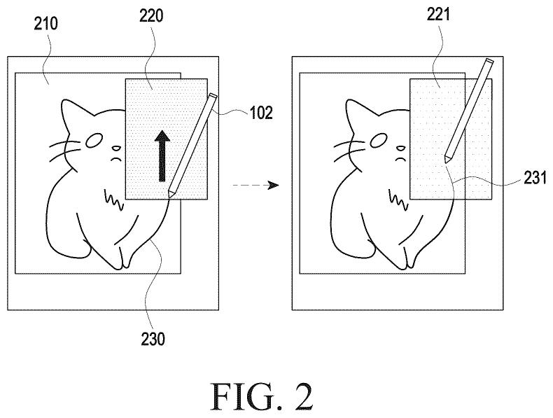

FIG. 2 is a diagram illustrating an example operation of an electronic device in an upper window in response to input on a lower window in a multi-window state according to various embodiments.

Referring to FIG. 2, an electronic device (e.g., the electronic device 101 in FIG. 1 or the processor 120 in FIG. 1) may display execution screens 210 and 220 of multiple applications on a display (or touch screen) (e.g., the display module 160 in FIG. 1) as multiple windows or pop-up windows. According to an embodiment, the execution screen of a first application may be displayed as a first window 210, the execution screen of a second application may be displayed as a second window 220, and the first window 210 and the second window 220 may be displayed at least partially overlapping.

According to an embodiment, in the case where a first window 210 is displayed as a lower window and a second window 220 is displayed as an upper window, an input is performed on the first window 210, which is the lower window, using a stylus pen 102 (e.g., the electronic device 102 in FIG. 1), the electronic device may display content 230 corresponding to the input on the first window 210.

According to an embodiment, when the input moves from the first window 210 to an area overlapping the second window 220, the electronic device may process the second window 220 so that the content obscured by the second window 220 is displayed.

For example, the electronic device may increase the transparency of the second window 220 and display content 231 in the area overlapping the second window 220 by transmitting the content through the second window 220 with the increased transparency 221.

According to an embodiment, the electronic device may generate content 231 corresponding to the input received in an area of the first window 210, overlapping the second window 220, as an upper layer of the second window 220, and display the content 231 to be overlaid on the second window 220.

In this way, when an input on the first window 210 moves to an area overlapping the second window 220, the content obscured by the second window 220 may be temporarily displayed by adjusting the transparency of the second window 220 or generating an upper layer, thereby ensuring operation continuity on the first window 210.

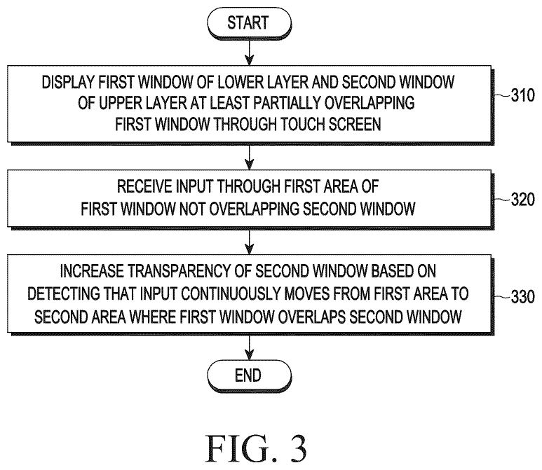

Hereinafter, various example embodiments for ensuring operation continuity on the first window 210, which is a lower window, will be described in greater detail with reference to FIGS. 3 to 14B.

FIG. 3 is a flowchart illustrating an example operation of an electronic device in an upper window in response to input on a lower window in a multi-window state according to various embodiments.

Referring to FIG. 3, in operation 310, an electronic device (e.g., the electronic device 101 in FIG. 1 or the processor 120 in FIG. 1) may display, through a touch screen (e.g., the display module 160 in FIG. 1), a first window of a lower layer and a second window of an upper layer that at least partially overlaps the first window.

According to an embodiment, the application whose execution screen is displayed in the first window may have coordinate information of the second window, such as its location and/or size, or the electronic device may provide coordinate information of the second window to the application whose execution screen is displayed in the first window.

According to an embodiment, in operation 320, the electronic device may receive an input through a first area of the first window that does not overlap the second window.

According to an embodiment, the input may include at least one of a drawing input or a text input. For example, the drawing input may include a sketch input and/or a text input. According to an embodiment, the sketch input and/or text input may include a straight-line input and/or a curved-line input.

According to an embodiment, the drawing input may be a handwriting input received through a stylus pen (e.g., the electronic device 102 in FIG. 1) or a finger touching the touch screen. According to an embodiment, the drawing input may be received through an input device (e.g., a mouse or drawing tablet) connected to the electronic device, instead of being input directly through the touch screen. According to an embodiment, if an input is received through an input device connected to the electronic device, the electronic device may include a display without touch functionality, rather than the touch screen.

According to an embodiment, the text input may be received through touching a soft key displayed on the touch screen, or may be received through physical keys included in the electronic device or an external keyboard connected to the electronic device.

According to an embodiment, the electronic device, based on an input being received in a first area of the first window that does not overlap the second window, may display, in the first window, content corresponding to the input. For example, when a drawing input is received on a first window, which is a note application, the electronic device may display, in the first window, drawing content corresponding to the drawing input.

According to an embodiment, in operation 330, the electronic device, based on detecting that the input continuously moves from the first area to a second area where the first window overlaps the second window, may change the configuration of at least a portion of the second window.

According to an embodiment, when the electronic device detects that the input continuously moves from the first area of the first window, which does not overlap the second window, to a second area that overlaps the second window, the electronic device may process the second window to display content corresponding to the input on the second area obscured by the second window. For example, the electronic device may increase the transparency of the second window, change the color of the second window (e.g., change to black and white), and/or hide the second window in order to display content corresponding to the input on the second area of the first window that overlaps the second window.

According to an embodiment, the electronic device may identify the first area and the second area, based on coordinate information of the second window, such as its location and/or size. According to an embodiment, when a cursor for touch or text input moves from the first area to the second area, the electronic device may identify that the input moves from the first area to the second area.

According to an embodiment, the electronic device may determine that the input moves continuously if a touch received in the first area of the first window moves continuously to the second area without being released.

According to an embodiment, if a touch received in the first area of the first window is released within a set distance from the boundary of the second window and then a touch is received again in the second area within a set time period, the electronic device may identify that the input moves continuously.

According to an embodiment, if a text input begins in the first area of the first window and text is input from the first area to the second area, based on the boundary of the second window, within a set time period, the electronic device may identify that the input moves continuously.

According to an embodiment, the electronic device may determine the transparency of the second window, based on at least one of the amount of content in the second window, the color of the content, the color of content corresponding to the input, or the thickness of the content corresponding to the input.

For example, depending on the amount of content included in the second window, the electronic device may determine the transparency of the second window to be a higher value if the amount of content is large. According to an embodiment, the electronic device may determine the transparency of the second window to be a first transparency, based on the amount of content in the second window being less than a set value, and may determine the transparency of the second window to be a second transparency, which is higher than the first transparency, based on the amount of content in the second window being greater than or equal to the set value. According to an embodiment, the electronic device may identify the amount of content in the second window, based on the number of lines, image ratio, and/or number of colors included in the second window.

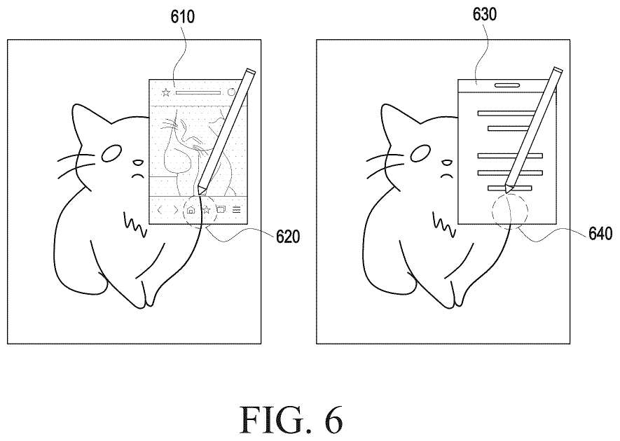

According to an embodiment, an embodiment of determining the transparency of the second window, based on the amount of content in the second window, will be described in greater detail below with reference to FIG. 6.

According to an embodiment, depending on the color of content included in the second window, the electronic device may determine the transparency of the second window to be a higher value if the color of the content is similar to the color of content associated with an input (e.g., a stroke input by a stylus pen and/or a text input by a keyboard). For example, the electronic device may determine the transparency of the second window to be a first transparency, based on the difference between a color value of the content in the second window and a color value of the content corresponding to the input being greater than or equal to a set value, and may determine the transparency of the second window to be a second transparency, which is higher than the first transparency, based on the difference between the color value of the content in the second window and the color value of the content corresponding to the input being less than the set value.

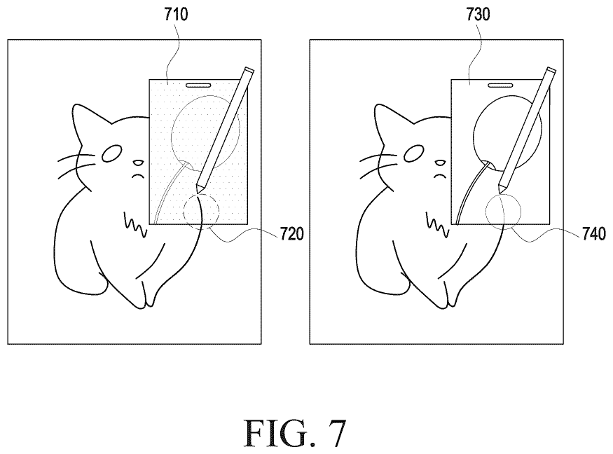

According to an embodiment, an embodiment of determining the transparency of the second window, based on the color of the content in the second window, will be described in greater detail below with reference to FIG. 7.

According to an embodiment, the electronic device may determine the transparency of the second window by considering both the amount and color of the content included in the second window. According to an embodiment, the electronic device may determine the transparency of the second window by further considering the thickness of a line, which is content corresponding to the input, in addition to the amount and/or color of the content included in the second window. For example, the electronic device may determine the transparency of the second window to be a higher value as the line corresponding to the input becomes thinner.

According to an embodiment, the electronic device may increase the transparency of the second window and display both the second window with increased transparency and the first window passing through the second window. According to an embodiment, the operation of adjusting the transparency of the second window to display both the first window and the second window may be referred to as “transparency adjustment (dim).”

According to an embodiment, the electronic device may increase the transparency of the second window to the maximum, thereby causing the second window to disappear and displaying only the first window. According to an embodiment, the electronic device may maintain the boundary of the second window as a solid or dotted line and adjust the transparency of the second window.

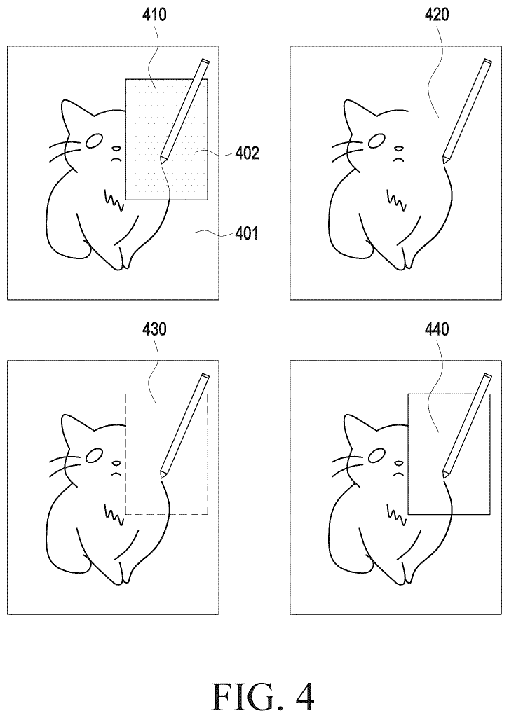

According to an embodiment, an example of adjusting the transparency of the second window will be described in greater detail below with reference to FIG. 4.

According to an embodiment, the electronic device may generate content corresponding to an input received in the second area of the first window overlapping the second window as an upper layer of the second window, and display the content corresponding to the input received in the second area to be overlaid on the second window. According to an embodiment, the electronic device may display the content corresponding to the input received in the second area to be overlaid on the second window whose transparency has not been adjusted, or to be overlaid on the second window whose transparency has been adjusted.

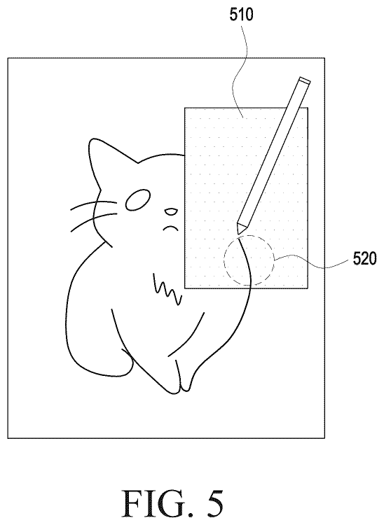

According to an embodiment, the operation of displaying the content corresponding to the input received in the second area to be overlaid as the upper layer of the second window will be described in greater detail below with reference to FIG. 5.

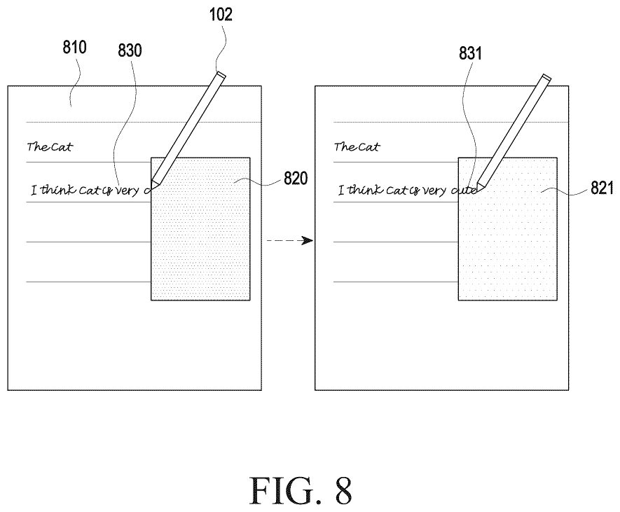

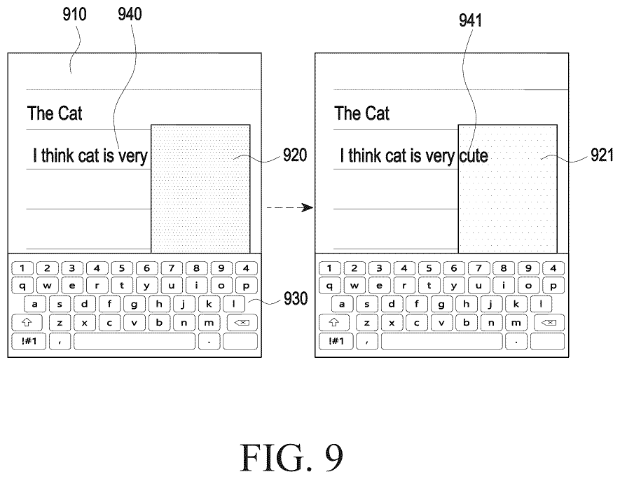

According to an embodiment, the input may include at least one of a drawing input including a handwriting input or a text input. According to an embodiment, an embodiment in which the input is a handwriting input will be described in greater detail below with reference to FIG. 8. According to an embodiment, an embodiment in which the input is a text input will be described in greater detail below with reference to FIG. 9.

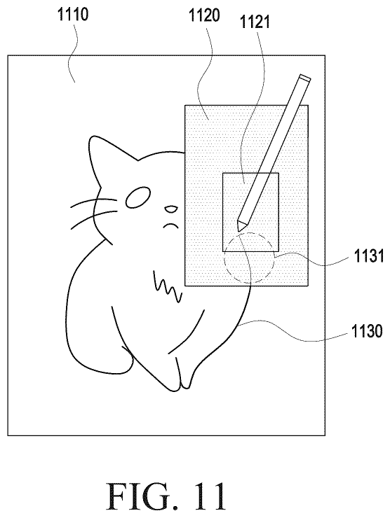

According to an embodiment, if there are two or more upper windows for the window in which the input originated in the state where three or more windows are displayed, the electronic device may increase the transparency of all upper windows for the window in which the input originated. According to an embodiment, the operation of the electronic device when three or more windows are displayed will be described in greater detail below with reference to FIG. 11.

According to an embodiment, the electronic device may control the touch screen so that the input received in the second area is displayed by passing through the second window.

According to an embodiment, the electronic device may display content corresponding to an input received in the second area of the first window overlapping the second window by transmitting the content through the second window with increased transparency.

According to an embodiment, the electronic device may maintain the increased transparency of the second window for a set time period after the input is completed, and display content corresponding to the input received in the second area by passing through the second window. According to an embodiment, the completion of the input may include a state in which a touch using a stylus pen or finger is released from the touch screen, a state in which a drawing input is not received through an input device, or a state in which an input using a soft key or physical key is not received.

According to an embodiment, the electronic device, based on a set time period elapsed after the input is completed, may change the transparency of the second window back to its original transparency so as not to display the content corresponding to the input received in the second area. For example, the electronic device may increase the transparency of the second window to display content corresponding to the input received in the second area through the second window, maintain the transparency of the second window for a set time period after the input is completed to display content corresponding to the input received in the second area through the second window, and, when the set time period has elapsed after the input is completed, restore the transparency of the second window to its previous transparency, making it opaque, thereby obscuring the content corresponding to the input received in the second area with the second window.

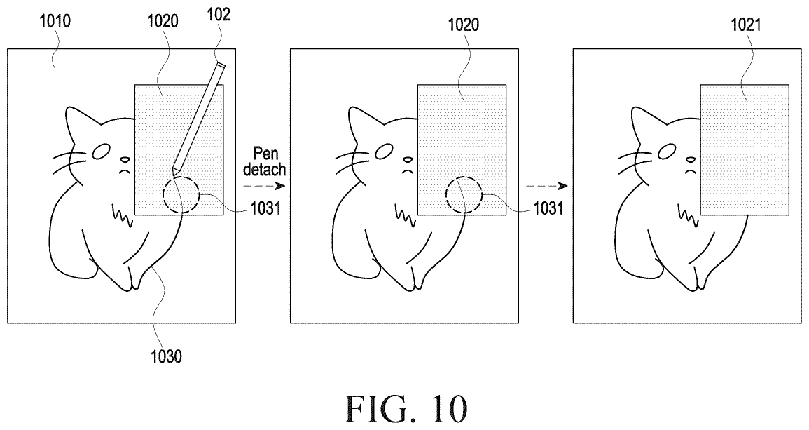

According to an embodiment, the operation of the electronic device after the input is completed will be described in greater detail below with reference to FIG. 10.

According to an embodiment, the electronic device, based on a second input received in the second area within a set time period after the input is completed, may identify the second input as an input in the first window. According to an embodiment, if a second input is received in the second area within a set time period after the touch is released, the electronic device may identify that the input is not completed and is in progress. According to an embodiment, the electronic device may display content corresponding to the second input q through the second window. For example, if the electronic device identifies that input is in progress due to the second input, the electronic device may maintain the increased transparency of the second window and display content corresponding to the second input by passing through the second window with the increased transparency.

According to an embodiment, the electronic device, based on a second input being received, after the input is completed, within a set distance from the location where the input is completed, may identify the second input as input in the first window. According to an embodiment, if a second input is received, after a touch is released, within a set distance from the released location, the electronic device may identify that the input is not completed and is in progress. According to an embodiment, if a second input is received within a set time period after a touch is released and within a set distance from the released location, the electronic device may identify that the input is in progress. According to an embodiment, the electronic device may display content corresponding to the second input by passing through the second window. For example, upon determining that input is in progress due to the second input, the electronic device may maintain the increased transparency of the second window and display content corresponding to the second input by passing through the second window with the increased transparency.

According to an embodiment, when an input in the first area of the first window that does not overlap the second window moves to the second area that overlaps the second window, the electronic device may move the location of the second window and display content corresponding to the input received in the second area. According to an embodiment, the electronic device may move the location while maintaining the size of the second window, or may reduce the size of the second window and then move the location.

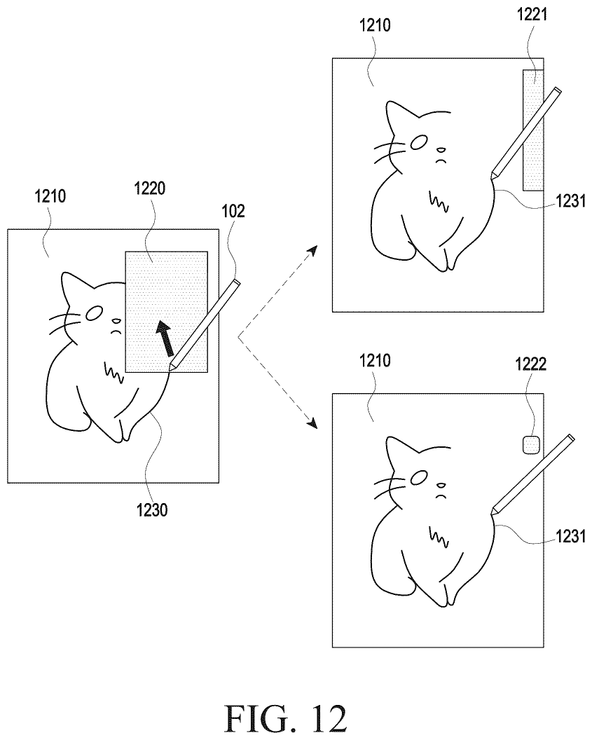

According to various embodiments moving the location of the second window according to an input in the first window will be described in greater detail below with reference to FIGS. 12, 13, 14A, and 14B.

FIG. 4 is a diagram illustrating an example operation of an electronic device for adjusting the transparency of an upper window in response to input on a lower window in a multi-window state according to various embodiments.

Referring to FIG. 4, in a multi-window state where a first window and a second window 410 overlap, when an input continuously moves from a first area 401 of the first window, which does not overlap the second window 410, to a second area 402 that overlaps the second window 410, an electronic device (e.g., the electronic device 101 in FIG. 1 or the processor 120 in FIG. 1) may increase the transparency of the second window 410 and display both the second window 410 with the increased transparency and the first window passing through the second window.

According to an embodiment, the electronic device may also increase the transparency of the second window to the maximum, thereby causing the second window to disappear 420 and displaying only the first window.

According to an embodiment, the electronic device may maintain the boundary of the second window as a dotted line 430 or a solid line 440 and adjust the transparency of the second window. For example, the electronic device may maintain the boundary of the second window as a dotted line 430 or a solid line 440 and increase the transparency of the second window to the maximum, thereby causing the content of the second window to disappear and displaying only the first window.

According to an embodiment, the electronic device may also generate the content of the first window obscured by the second window as an upper layer of the second window and display it overlaid on the second window, as illustrated in FIG. 5.

FIG. 5 is a diagram illustrating an example operation of an electronic device for overlaying an upper window in response to input on a lower window in a multi-window state according to various embodiments.

Referring to FIG. 5, in a multi-window state where a first window and a second window 510 overlap, when an input continuously moves from a first area of the first window, which does not overlap the second window 510, to a second area that overlaps the second window 510, an electronic device (e.g., the electronic device 101 in FIG. 1 or the processor 120 in FIG. 1) may generate content 520 corresponding to an input received in the second area as an upper layer of the second window, and display the content 520 corresponding to the input received in the second area to be overlaid on the second window. According to an embodiment, the operation of generating the content 520 corresponding to the input received in the second area as an upper layer of the second window and displaying it to be overlaid on the second window may be referred to as an “overlay.”

According to an embodiment, the electronic device may display the content 520 corresponding to the input received in the second area to be overlaid on the second window without adjusting the transparency of the second window, or to be overlaid on the second window with increased transparency.

According to an embodiment, as illustrated in FIG. 4, an example in which the transparency of the second window is increased to the maximum to make it disappear, or in which only the boundary of the second window is maintained as a dotted or solid line is intended to not display the content of the second window. According to an embodiment, an example in which the transparency of the second window is adjusted to display both the first window and the second window, as illustrated in FIG. 4, or an example in which the content 520 corresponding to the input received in the second area is generated as an upper layer of the second window and displayed to be overlaid on the second window, as illustrated in FIG. 5, is intended to display the content of the second window.

According to an embodiment, the electronic device may determine whether to display content of the second window and determine a method of processing the second window, based on the function (or input) of the first window and/or the type of content of the second window, as shown in Table 1 below.

TABLE 1

| First window | Second window | |
|---|---|---|
| function | content type | Window processing method |
| Pen input | Text | Disappear, dotted line |
| | | display, solid line display |
| | Image, video | Transparency adjustment, |
| | | overlay |
| Text input | Text | Disappear, dotted line |
| | | display, solid line display |
| | Image, video | Transparency adjustment, |
| | | overlay |

According to an embodiment, the type of content in the second window may be determined based on the area ratio of the content displayed in the second window. For example, if the area occupied by an image or video in the second window is greater than or equal to a set n %, the electronic device may determine that the type of content in the second window is an image or video. According to an embodiment, referring to Table 1, if the content of the second window is text, and if the input on the first window is a pen input or text input, it is difficult to distinguish the content corresponding to the input due to the overlap with the text in the second window, so the electronic device may process the second window as “disappear,” “dotted line display,” or “solid line display” to maximize the transparency of the second window.

According to an embodiment, if the content of the second window is an image or video, and if the input on the first window is a pen input or text input, the electronic device may process the second window as “transparency adjustment” or “overlay” to display the content of the second window together. According to an embodiment, the electronic device may determine the transparency of the second window differently based on at least one of the amount of content in the second window, the color of the content, the color of content corresponding to an input on the first window, or the thickness of the content corresponding to the input.

FIG. 6 is a diagram illustrating an example operation of an electronic device for adjusting the transparency of an upper window depending on the amount of content on the upper window in a multi-window state according to various embodiments.

Referring to FIG. 6, in a multi-window state where a first window and a second window overlap, when an input continuously moves from a first area of the first window, which does not overlap the second window, to a second area that overlaps the second window, an electronic device (e.g., the electronic device 101 in FIG. 1 or the processor 120 in FIG. 1) may increase the transparency of the second window, and display both the second window with the increased transparency and the first window passing through the second window.

According to an embodiment, depending on the amount of content included in the second window, the electronic device may determine the transparency of the second window to a higher value if the amount of content is large. According to an embodiment, the electronic device may determine the transparency of the second window to be a first transparency, based on the amount of content in the second window being less than a set value, and may determine the transparency of the second window to be a second transparency, which is higher than the first transparency, based on the amount of content in the second window being greater than or equal to the set value. According to an embodiment, the electronic device may identify the amount of content in the second window, based on the number of lines, image ratio, and/or number of colors included in the second window.

For example, if the number of images in the second window is large, the electronic device may change the transparency of the second window to a higher transparency. According to an embodiment, the electronic device may display content 620 corresponding to an input received in an area, where the first and second windows overlap, by transmitting it through the second window 610, which has been changed to a higher transparency, e.g., a second transparency.

According to an embodiment, if the number of images or the amount of content is small in the second window due to the presence of wide margins, the electronic device may change the transparency of the second window to minimize/reduce the amount of change in the transparency. According to an embodiment, the electronic device may display content 640 corresponding to an input received in a second area, where the first window and the second window overlap, by transmitting it through the second window 630, which has been changed to a first transparency lower than the second transparency. In this way, when the amount of content included in the second window is small, it is possible to distinguish the content corresponding to the input received in the second area of the first window even without increasing the transparency of the second window. Therefore, the amount of resources used to adjust the transparency of the second window and display the content corresponding to the input received in the second area of the first window may be reduced.

According to an embodiment, the electronic device may determine the transparency of the second window by further considering the thickness of the line, which is the content corresponding to the input received in the second area of the first window overlapping the second window, in addition to the amount of content included in the second window.

According to an embodiment, the electronic device may determine the transparency of the second window, based on the thickness of the line of the content corresponding to the input received in the second area and the thickness of the line included in the second window.

For example, if the thickness of the line of the content corresponding to the input received in the second area of the first window overlapping the second window is greater than or equal to a set value or is greater than the thickness of the line included in the second window, the electronic device may determine the amount of increase in transparency of the second window to be a smaller value. In this way, if the thickness of the content corresponding to the received input is great, it is possible to distinguish the content corresponding to the input received in the second area of the first window without increasing the transparency of the second window. Therefore, the amount of resources used to adjust the transparency of the second window and display the content corresponding to the input received in the second area of the first window may be reduced.

FIG. 7 is a diagram illustrating an example operation of an electronic device for adjusting the transparency of an upper window depending on the color of content on the upper window in a multi-window state according to various embodiments.

Referring to FIG. 7, in a multi-window state where a first window and a second window overlap, when an input continuously moves from a first area of the first window, which does not overlap the second window, to a second area that overlaps the second window, an electronic device (e.g., the electronic device 101 in FIG. 1 or the processor 120 in FIG. 1) may increase the transparency of the second window, and display both the second window with the increased transparency and the first window passing through the second window.

According to an embodiment, if the color of content included in the second window and the color of content corresponding to the input received in the second area of the first window that overlaps the second window are similar, the electronic device may determine the transparency of the second window to be a high value. For example, the electronic device may determine the transparency of the second window to be a first transparency, based on a difference between a color value of the content of the second window and a color value of the content corresponding to the input being greater than or equal to a set value, and may determine the transparency of the second window to be a second transparency, which is higher than the first transparency, based on a difference between the color value of the content of the second window and the color value of the content corresponding to the input being less than the set value.

For example, if the color value of the content of the second window corresponds to sky blue, and the color value of the content corresponding to the input corresponds to blue, resulting in a small color difference, the electronic device may change the transparency of the second window to a high transparency. According to an embodiment, the electronic device may display content 720 corresponding to the input received in an area, where the first window and the second window overlap, by passing through the second window 710 that has been changed to the high transparency, e.g., the second transparency.

According to an embodiment, if the color value of the content of the second window corresponds to orange and the color value of the content corresponding to the input corresponds to blue, resulting in a significant color difference, the electronic device may change the transparency of the second window to minimize/reduce the amount of change in transparency. According to an embodiment, the electronic device may display content 740 corresponding to the input received in the second area, where the first window and the second window overlap, by passing through the second window 730 that has been changed to a first transparency, which is lower than the second transparency. In this way, if the difference between the color value of the content of the second window and the color value of the content corresponding to the input is significant, it is possible to distinguish the content corresponding to the input received in the second area of the first window even without increasing the transparency of the second window. Therefore, the amount of resources used to adjust the transparency of the second window and display the content corresponding to the input received in the second area of the first window may be reduced.

According to an embodiment, the electronic device may determine the transparency of the second window by further considering the thickness of the line, which is the content corresponding to the input received in the second area of the first window overlapping the second window, in addition to the color of the content included in the second window.

For example, if the thickness of the line, which is the content corresponding to the input received in the second area of the first window overlapping the second window, is great, it is possible to distinguish the content corresponding to the input received in the second area of the first window even without increasing the transparency of the second window. Therefore, the amount of resources used to adjust the transparency of the second window and display the content corresponding to the input received in the second area of the first window may be reduced.

FIG. 8 is a diagram illustrating an example operation of an electronic device for adjusting the transparency of an upper window according to a handwriting operation in a multi-window state according to various embodiments.

Referring to FIG. 8, an electronic device (e.g., the electronic device 101 in FIG. 1 or the processor 120 in FIG. 1) may display a first window 810 and a second window 820 that at least partially overlaps the first window 810 and is an upper layer of the first window 810. For example, the first window 810 may be an execution screen of a note application capable of handwriting input.

According to an embodiment, the electronic device may receive a handwriting input 830 (e.g., characters or drawings) through a stylus pen 102 (e.g., the electronic device 102 in FIG. 1) in a first area of the first window 810 that does not overlap the second window 820. According to an embodiment, the electronic device may receive the input not only through a touch using the stylus pen 102 but also through a touch using a finger, and may receive an input through an input device (e.g., a mouse or drawing tablet) connected to the electronic device without touching a touch screen (e.g., the display module 160 in FIG. 1).

According to an embodiment, when the handwriting input received in the first area of the first window 810 that does not overlap the second window 820 continuously moves to a second area that overlaps the second window 820, the electronic device may increase the transparency of the second window 820.

According to an embodiment, the electronic device may determine the transparency of the second window 820, based on the type of content included in the second window 820, the amount of the content, the color of the content, the color of the handwriting input 830 displayed in the first window 810, and/or the thickness of the line of the handwriting input 830.

According to an embodiment, the electronic device may display content 831 corresponding to the handwriting input received in the second area by passing through the second window 821 with the increased transparency.

FIG. 9 is a diagram illustrating an example operation of an electronic device for adjusting the transparency of an upper window according to a text input operation in a multi-window state according to various embodiments.

Referring to FIG. 9, an electronic device (e.g., the electronic device 101 in FIG. 1 or the processor 120 in FIG. 1) may display a first window 910 and a second window 920 that at least partially overlaps the first window 910 and is an upper layer of the first window 910.

According to an embodiment, the electronic device may display soft keys 930 for text input in the first window 910. According to an embodiment, the electronic device may also receive a text input through physical keys provided on the electronic device and/or an external keyboard connected to the electronic device, instead of through the soft keys 930.

According to an embodiment, the electronic device may display text 940 corresponding to the input in a first area of the first window 910 that does not overlap the second window 920.

According to an embodiment, the electronic device may display text 940 corresponding to the input in a first area of the first window 910 that does not overlap the second window 920, and, if the text 940 is displayed on the boundary of the second window 920, increase the transparency of the second window 920.

According to an embodiment, the electronic device may determine the transparency of the second window 920, based on the amount of content included in the second window 920, the color of the content, and the color and/or thickness of the text 940 displayed in the first window 910.

According to an embodiment, the electronic device may change the transparency of the second window 920, and the text 941 displayed in the second area may be displayed by passing through the second window 921 with the increased transparency.

FIG. 10 is a diagram illustrating an example operation of an electronic device after input is terminated in a multi-window state according to various embodiments.

Referring to FIG. 10, an electronic device (e.g., the electronic device 101 in FIG. 1 or the processor 120 in FIG. 1) may display a first window 1010 and a second window 1020 that at least partially overlaps the first window 1010 and is an upper layer of the first window 1010. For example, the first window 1010 may be an execution screen of a note application capable of handwriting input.

According to an embodiment, the electronic device may receive a handwriting input 1030 (e.g., characters or drawings) through a stylus pen 102 (e.g., the electronic device 102 in FIG. 1) in a first area of the first window 1010 that does not overlap the second window 1020. According to an embodiment, the electronic device may receive the input not only through a touch using the stylus pen 102 but also through a touch using a finger, and may receive an input through an input device (e.g., a mouse or drawing tablet) connected to the electronic device without touching a touch screen (e.g., the display module 160 in FIG. 1).

According to an embodiment, when the handwriting input 1030 received in the first area of the first window 1010 that does not overlap the second window 1020 continuously moves to a second area that overlaps the second window 1020, the electronic device may increase the transparency of the second window 1020.

According to an embodiment, the electronic device may determine the transparency of the second window 1020, based on the amount of content included in the second window 1020, the color of the content, the color of the handwriting input 1030 displayed in the first window 1010, and/or the thickness of the line of the handwriting input 1030.

According to an embodiment, the electronic device may display content 1031 corresponding to the handwriting input received in the second area by passing through the second window 1020 with the increased transparency.

According to an embodiment, the electronic device may maintain the increased transparency of the second window 1020 for a set time period after the input is completed, and display content 1031 corresponding to the handwriting input received in the second area by passing through the second window 1020 with the increased transparency. For example, if a touch of the stylus pen 102 or finger is released, or if no input is received from an input device connected to the electronic device, the electronic device may maintain the increased transparency of the second window 1020 for a set time period, and display content 1031 corresponding to the handwriting input received in the second area by passing through the second window 1020 with the increased transparency.

According to an embodiment, when the set time period has elapsed after the input is completed, the electronic device may change the transparency of the second window back to the original transparency so that the content corresponding to the input received in the second area is not displayed. For example, the electronic device may increase the transparency of the second window to display content corresponding to the input received in the second area through the second window, maintain the transparency of the second window for a set time period after the input is completed to display the content corresponding to the input received in the second area through the second window, and, when a set time period has elapsed after the input is completed, restore the transparency of the second window to its previous transparency to make it opaque, thereby covering the content corresponding to the input received in the second area with the opaque second window 1021.

According to an embodiment, the electronic device, based on a second input being received in the second area within a set time period after the input is completed, may identify the second input as an input to the first window 1010. According to an embodiment, if a second input is received in the second area within a set time period after a touch is released, the electronic device may identify that the input is not completed and is in progress. According to an embodiment, the electronic device may display content 1031 corresponding to the second input by passing through the second window 1020. For example, when the electronic device determines that input is in progress due to the second input, the electronic device may maintain the increased transparency of the second window 1020 and display the content 1031 corresponding to the second input by passing through the second window 1020 with the increased transparency.

According to an embodiment, the electronic device, based on a second input being received in a second area overlapping the second window 1021 when a set time period has elapsed after the input is completed, may identify the second input as an input to the second window 1021. According to an embodiment, when a set time period has elapsed after the input is completed, the electronic device may restore the transparency of the second window to its previous transparency to make it opaque, and display the content corresponding to the second input received in the second area on the second window 1021.

According to an embodiment, the electronic device, based on a second input being received after the input is completed within a set distance from the location where the input is completed, may identify the second input as an input to the first window 1010. According to an embodiment, if a second input is received after a touch is released within a set distance from the released location, the electronic device may identify that the input is not completed and is in progress. According to an embodiment, if a second input is received within a set time period after a touch is released and within a set distance from the released location, the electronic device may identify that the input is in progress. According to an embodiment, the electronic device may display content 1031 corresponding to the second input by passing through the second window. For example, when the electronic device identifies that the input is in progress due to the second input, the electronic device may maintain the increased transparency of the second window 1020 and display the content 1031 corresponding to the second input by passing through the second window 1020 with the increased transparency.

According to an embodiment, the electronic device, based on a second input being received after the input is completed beyond the set distance from the location where the input is completed, may identify the second input as an input to the second window 1021. According to an embodiment, when a second input is received after the input is completed beyond the set distance from the location where the input is completed, the electronic device may restore the transparency of the second window to its previous transparency to make it opaque, and display content corresponding to the second input received in the second area on the second window 1021.

FIG. 11 is a diagram illustrating an example operation of an electronic device for adjusting the transparency of two upper windows in a multi-window state including three or more windows according to various embodiments.

Referring to FIG. 11, an electronic device (e.g., the electronic device 101 in FIG. 1 or the processor 120 in FIG. 1) may display a first window 1110, and a second window 1120 and a third window 1121 that at least partially overlap the first window 1110 and are upper layers of the first window 1110. For example, the first window 1010 may be an execution screen of a note application capable of handwriting input. According to an embodiment, there may be two or more windows 1120 and 1121 that are upper layers of the first window 1110.

According to an embodiment, the electronic device may receive a handwriting input 1130 (e.g., characters or drawings) through a stylus pen 102 (e.g., the electronic device 102 in FIG. 1) in a first area of the first window 1110 that does not overlap the second window 1120 and the third window 1121. According to an embodiment, the electronic device may receive the input not only through a touch using the stylus pen 102 but also through a touch using a finger, and may receive an input through an input device (e.g., a mouse or drawing tablet) connected to the electronic device without touching a touch screen (e.g., the display module 160 in FIG. 1).

According to an embodiment, when a handwriting input 1130 received in a first area of the first window 1110 that does not overlap the second window 1120 and the third window 1121 continuously moves to a second area that overlaps the second window 1120, the electronic device may increase the transparency of the second window 1120. According to an embodiment, if at least a portion of the third window 1121 is included in the second area, the electronic device may also increase the transparency of the third window 1121.

According to an embodiment, the electronic device may determine the transparency of the second window 1120 and the third window 1121, based on the amount of content included in the second window 1120 and the third window 1121, the color of the content, the color of the handwriting input 1130 displayed in the first window 1110, and/or the thickness of the line of the handwriting input 1130.

According to an embodiment, the electronic device may display content 1131 corresponding to the handwriting input received in the second area by passing through the second window 1120 and third window 1121 with the increased transparency.

Although the first window 1110 is illustrated and described as being the lowest layer in FIG. 11, according to an embodiment, a window that is a layer lower than the first window 1110 may be included, and the layer lower than the first window 1110 may be a home screen or an application execution screen.

FIG. 12 is a diagram illustrating an example operation of an electronic device for moving an upper window in response to input on a lower window in a multi-window state according to various embodiments.

Referring to FIG. 12, an electronic device (e.g., the electronic device 101 in FIG. 1 or the processor 120 in FIG. 1) may display a first window 1210 and a second window 1220 that at least partially overlaps the first window 1210 and is an upper layer of the first window 1210. For example, the first window 1210 may be an execution screen of a note application capable of handwriting input.

According to an embodiment, the electronic device may receive a handwriting input 1230 (e.g., characters or drawings) through a stylus pen 102 (e.g., the electronic device 102 in FIG. 1) in a first area of the first window 1210 that does not overlap the second window 1220. According to an embodiment, the electronic device may receive the input not only through a touch using the stylus pen 102 but also through a touch using a finger, and may receive an input through an input device (e.g., a mouse or drawing tablet) connected to the electronic device without touching a touch screen (e.g., the display module 160 in FIG. 1).

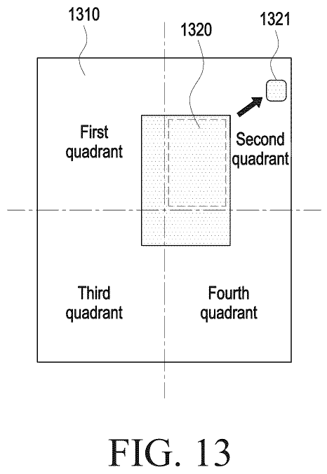

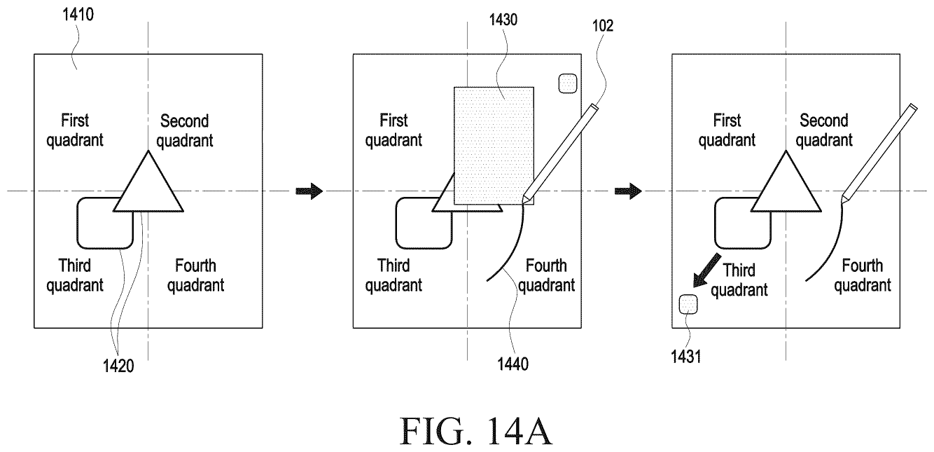

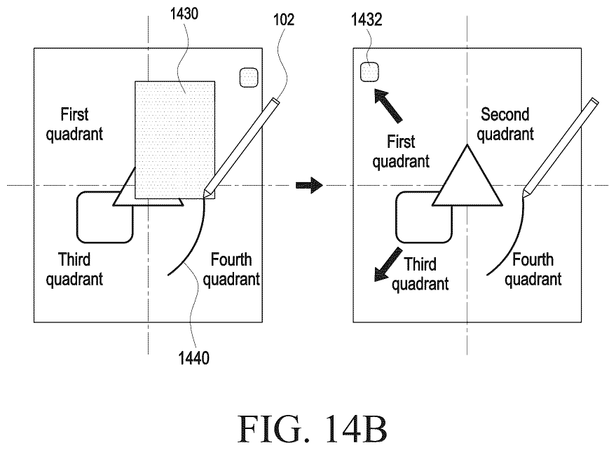

According to an embodiment, when a handwriting input 1230 received in a first area of the first window 1210 that does not overlap the second window 1220 continuously moves to a second area that overlaps the second window 1220, the electronic device may move the location of the second window 1220. For example, the electronic device may move the second window 1220 so that at least a portion of the second window 1220 is hidden from the screen. For example, the electronic device may display only a partial area 1221 of the second window 1220. According to an embodiment, the location to which the second window 1220 is moved will be described in greater detail below with reference to FIGS. 13, 14A, and 14B.

According to an embodiment, as the second window 1220 is moved so that only a partial area 1221 is displayed, the electronic device may display content 1231 corresponding to the received handwriting input without being obscured by the second window 1220.

According to an embodiment, when the handwriting input 1230 received in the first area of the first window 1210 that does not overlap the second window 1220 continuously moves to a second area that overlaps the second window 1220, the electronic device may reduce the size of the second window 1220 and move its location. For example, the electronic device may change the second window 1220 to an icon 1222 related to the second window 1220 and move the icon 1222 to near the boundary of the display (e.g., the display module 160 in FIG. 1). According to an embodiment, the location to which the icon 1222 is moved will be described in more detail with reference to FIGS. 13, 14A, and 14B.

According to an embodiment, as the icon 1222 obtained by reducing the size of the second window 1220 is moved, the electronic device may display content 1231 corresponding to the received handwriting input without being obscured by the second window 1220.

FIG. 13 is a diagram illustrating an example operation of an electronic device for moving an upper window depending on the location of the upper window in a multi-window state according to various embodiments.

Referring to FIG. 13, an electronic device (e.g., the electronic device 101 in FIG. 1 or the processor 120 in FIG. 1) may display a first window 1310 and a second window 1320 that at least partially overlaps the first window 1310 and is an upper layer of the first window 1310.

According to an embodiment, the electronic device may move the second window 1320 to a quadrant in which a large portion of the second window 1320 is displayed, among the four quadrants obtained by dividing the first window 1310, or may move a reduced-size second window 1321. For example, in a case where a large portion of the second window 1320 is displayed in the second quadrant among the four quadrants of the first window 1310, and where a handwriting input received in the first area of the first window 1310 that does not overlap the second window 1320 continuously moves to the second area that overlaps the second window 1320, the electronic device may move the location of the second window 1320 to the second quadrant, or may reduce the size of the second window 1320 and then move it to the second quadrant.

FIG. 14A is a diagram illustrating an example operation of an electronic device for moving an upper window depending on the location of content included in a lower window in a multi-window state according to various embodiments.

Referring to FIG. 14A, an electronic device (e.g., the electronic device 101 in FIG. 1 or the processor 120 in FIG. 1) may display a first window 1410 and a second window 1430 that at least partially overlaps the first window 1410 and is an upper layer of the first window 1410. According to an embodiment, the first window 1410 may include at least one piece of content 1420. For example, the at least one piece of content 1420 may be placed most densely in the third quadrant among the four quadrants of the first window 1410, and the amount of content in the first window 1410 may be arranged in descending order of the third quadrant, the fourth quadrant, the first quadrant, and the second quadrant.

According to an embodiment, when a handwriting input 1440 received through a stylus pen 102 (e.g., the electronic device 102 in FIG. 1) in a first area of the first window 1410 that does not overlap the second window 1430 continuously moves to a second area that overlaps the second window 1430, the electronic device may move the second window 1430 to the third quadrant of the first window 1410 where the greatest amount of content is disposed, or move a reduced-size second window 1431 to the third quadrant.

In this way, since the area in the first window where a large amount of content is disposed has a small area capable of receiving input, the second window may be moved to the area where a large amount of content is disposed, thereby ensuring continuity of input on the first window.

FIG. 14B is a diagram illustrating an example operation of an electronic device for moving an upper window depending on the location of content included in a lower window and the input location in a multi-window state according to various embodiments.

Referring to FIG. 14B, when a handwriting input 1440 received through a stylus pen 102 (e.g., the electronic device 102 in FIG. 1) in a first area of the first window that does not overlap the second window 1430 continuously moves to a second area that overlaps the second window 1430, an electronic device (e.g., the electronic device 101 in FIG. 1 or the processor 120 in FIG. 1) may move the second window 1430, based on the location where the input is received. For example, the electronic device may exclude the fourth quadrant in which a touch is being performed by the stylus pen 102, among the four quadrants of the first window, from the movement location of the second window 1430. According to an embodiment, the electronic device may move the second window 1430 to the first quadrant, excluding the second and third quadrants adjacent to the fourth quadrant where a touch is being performed by the stylus pen 102, among the remaining first, second, and third quadrants, or may move a reduced-size second window 1432.

In this way, the second window may be moved based on the location where the input is received, thereby ensuring continuity of the input on the first window.

According to an example embodiment, the electronic device may include a touch screen, at least one processor comprising processing circuitry, and memory storing instructions.

According to an example embodiment, the instructions that, when executed by at least one processor individually or collectively, may cause the electronic device to display, through the touch screen, a first window of a lower layer and a second window of an upper layer at least partially overlapping the first window.

According to an example embodiment, the instructions that, when executed by at least one processor individually or collectively, may cause the electronic device to receive an input through a first area of the first window that does not overlap the second window.

According to an example embodiment, the instructions that, when executed by at least one processor individually or collectively, may cause the electronic device to increase, based on detecting that the input continuously moves from the first area to a second area where the first window is overlapped with the second window, the transparency of the second window.

According to an example embodiment, the instructions that, when executed by at least one processor individually or collectively, may cause the electronic device to determine the transparency of the second window, based on at least one of an amount of content of the second window, a color of the content of the second window, a color of content corresponding to the input, or a thickness of the content corresponding to the input.

According to an example embodiment, the instructions that, when executed by at least one processor individually or collectively, may cause the electronic device to determine, based on the amount of the content of the second window being less than a set value, the transparency of the second window to be a first transparency.

According to an example embodiment, the instructions that, when executed by at least one processor individually or collectively, may cause the electronic device to determine, based on the amount of the content of the second window being equal to or greater than the set value, the transparency of the second window to be a second transparency higher than the first transparency.

According to an example embodiment, the instructions that, when executed by at least one processor individually or collectively, may cause the electronic device to determine, based on a difference between a color value of the content in the second window and a color value of the content corresponding to the input being equal to or greater than a set value, the transparency of the second window to be a first transparency.

According to an example embodiment, the instructions that, when executed by at least one processor individually or collectively, may cause the electronic device to determine, based on the difference between the color value of the content of the second window and the color value of the content corresponding to the input being less than the set value, the transparency of the second window to be a second transparency higher than the first transparency.

According to an example embodiment, the instructions that, when executed by at least one processor individually or collectively, may cause the electronic device to maintain the increased transparency of the second window for a set time period after the input is completed.

According to an example embodiment, the instructions that, when executed by at least one processor individually or collectively, may cause the electronic device to change, based on the set time period elapsed after the input is completed, the transparency of the second window back to an original transparency so that the content corresponding to the input received in the second area is not displayed.

According to an example embodiment, the instructions that, when executed by at least one processor individually or collectively, may cause the electronic device to identify, based on a second input being received in the second area within a set time period after the input is completed, the second input as an input to the first window.

According to an example embodiment, the instructions that, when executed by at least one processor individually or collectively, may cause the electronic device to may maintain the increased transparency of the second window.

According to an example embodiment, the instructions that, when executed by at least one processor individually or collectively, may cause the electronic device to identify, based on a second input being received within a set distance from a location where the input is completed after the input is completed, the second input as an input to the first window.

According to an example embodiment, the instructions that, when executed by at least one processor individually or collectively, may cause the electronic device to maintain the increased transparency of the second window.

According to an example embodiment, the instructions that, when executed by at least one processor individually or collectively, may cause the electronic device to generate the content corresponding to the input received in the second area as an upper layer of the second window.

According to an example embodiment, the instructions that, when executed by at least one processor individually or collectively, may cause the electronic device to display the content corresponding to the input received in the second area to be overlaid on the second window.

According to an example embodiment, the input may include at least one of a drawing input or a text input.

According to an example embodiment, a control method of an electronic device may include displaying, through a touch screen of the electronic device, a first window of a lower layer and a second window of an upper layer at least partially overlapping the first window.

According to an example embodiment, the control method of an electronic device may include receiving an input through a first area of the first window that does not overlap the second window.

According to an example embodiment, the control method of an electronic device may include increasing, based on detecting that the input continuously moves from the first area to a second area where the first window is overlapped with the second window, the transparency of the second window.

According to an example embodiment, the increasing of the transparency of the second window may include determining the transparency of the second window, based on at least one of the amount of content of the second window, a color of the content of the second window, a color of content corresponding to the input, or a thickness of the content corresponding to the input.

According to an example embodiment, the increasing of the transparency of the second window may include determining, based on the amount of the content of the second window being less than a set value, the transparency of the second window to be a first transparency.

According to an example embodiment, the increasing of the transparency of the second window may include determining, based on the amount of the content of the second window being greater than or equal to the set value, the transparency of the second window to be a second transparency, which is higher than the first transparency.

According to an example embodiment, the increasing of the transparency of the second window may include determining, based on a difference between a color value of the content of the second window and a color value of the content corresponding to the input being equal to or greater than a set value, the transparency of the second window to be a first transparency.

According to an example embodiment, the increasing of the transparency of the second window may include determining, based on the difference between the color value of the content of the second window and the color value of the content corresponding to the input being less than the set value, the transparency of the second window to be a second transparency, which is higher than the first transparency.

According to an example embodiment, the control method of an electronic device may further include maintaining the increased transparency of the second window for a set time period after the input is completed.

According to an example embodiment, the control method of an electronic device may further include changing, based on the set time period elapsed after the input is completed, the transparency of the second window back to an original transparency so that the content corresponding to the input received in the second area is not displayed.

According to an example embodiment, the control method of an electronic device may further include identifying, based on a second input being received in the second area within a set time period after the input is completed, the second input as an input to the first window.

According to an example embodiment, the control method of an electronic device may further include maintaining the increased transparency of the second window.

According to an example embodiment, the control method of an electronic device may further include identifying, based on a second input being received after the input is completed within a set distance from a location where the input is completed, the second input as an input to the first window.

According to an example embodiment, the control method of an electronic device may further include maintaining the increased transparency of the second window.

According to an example embodiment, the control method of an electronic device may further include generating the content corresponding to the input received in the second area as an upper layer of the second window.

According to an example embodiment, the control method of an electronic device may further include displaying the content corresponding to the input received in the second area to be overlaid on the second window.

According to an example embodiment, the input may include at least one of a drawing input or a text input.

According to an example embodiment, a non-transitory computer-readable recording medium may store one or more programs, and the one or more programs may include instructions for causing the electronic device to display, through the touch screen, a first window of a lower layer and a second window of an upper layer at least partially overlapping the first window.

According to an example embodiment, the one or more programs may include instructions for causing the electronic device to receive an input through a first area of the first window that does not overlap the second window.

According to an example embodiment, the one or more programs may include instructions for causing the electronic device to increase, based on detecting that the input continuously moves from the first area to a second area where the first window is overlapped with the second window, the transparency of the second window.

According to an example embodiment, the one or more programs may include instructions for causing the electronic device to determine the transparency of the second window, based on at least one of an amount of content of the second window, a color of the content of the second window, a color of content corresponding to the input, or a thickness of the content corresponding to the input.

According to an example embodiment, the one or more programs may include instructions for causing the electronic device to determine, based on the amount of the content of the second window being less than a set value, the transparency of the second window to be a first transparency.

According to an example embodiment, the one or more programs may include instructions for causing the electronic device to determine, based on the amount of the content of the second window being equal to or greater than the set value, the transparency of the second window to be a second transparency higher than the first transparency.

According to an example embodiment, the one or more programs may include instructions for causing the electronic device to determine, based on a difference between a color value of the content in the second window and a color value of the content corresponding to the input being equal to or greater than a set value, the transparency of the second window to be a first transparency.

According to an example embodiment, the one or more programs may include instructions for causing the electronic device to determine, based on the difference between the color value of the content of the second window and the color value of the content corresponding to the input being less than the set value, the transparency of the second window to be a second transparency higher than the first transparency.

According to an example embodiment, the one or more programs may include instructions for causing the electronic device to maintain the increased transparency of the second window for a set time period after the input is completed.

According to an example embodiment, the one or more programs may include instructions for causing the electronic device to change, based on the set time period elapsed after the input is completed, the transparency of the second window back to an original transparency so that the content corresponding to the input received in the second area is not displayed.

According to an example embodiment, the one or more programs may include instructions for causing the electronic device to identify, based on a second input being received in the second area within a set time period after the input is completed, the second input as an input to the first window.

According to an example embodiment, the one or more programs may include instructions for causing the electronic device to maintain the increased transparency of the second window.

According to an example embodiment, the one or more programs may include instructions for causing the electronic device to identify, based on a second input being received after the input is completed within a set distance from a location where the input is completed, the second input as an input to the first window.

According to an example embodiment, the one or more programs may include instructions for causing the electronic device to maintain the increased transparency of the second window.

According to an example embodiment, the one or more programs may include instructions for causing the electronic device to generate the content corresponding to the input received in the second area as an upper layer of the second window.

According to an example embodiment, the one or more programs may include instructions for causing the electronic device to display the content corresponding to the input received in the second area to be overlaid on the second window.

According to an example embodiment, the input may include at least one of a drawing input or a text input.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with an embodiment of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a touch screen;
at least one processor, comprising processing circuitry; and
memory storing instructions that, when executed by at least one processor individually or collectively, cause the electronic device to:
display, through the touch screen, a first window as a lower layer and a second window as an upper layer at least partially overlapping the first window;
receive an input through a first area, not overlapping the second window, of the first window; and
increase, based on detecting that the input continuously moves from the first area to a second area where the first window is overlapped with the second window, a transparency of the second window.

2. The electronic device of claim 1,
wherein the instructions, when executed by at least one processor individually or collectively, cause the electronic device to determine the transparency of the second window based on at least one of an amount of content of the second window, a color of the content of the second window, a color of content corresponding to the input, and/or a thickness of the content corresponding to the input.

3. The electronic device of claim 2,
wherein the instructions, when executed by at least one processor individually or collectively, cause the electronic device to:
determine, based on the amount of the content of the second window being less than a set value, the transparency of the second window as a first transparency; and
determine, based on the amount of the content of the second window being equal to or greater than the set value, the transparency of the second window as a second transparency higher than the first transparency.

4. The electronic device of claim 2,
wherein the instructions, when executed by at least one processor individually or collectively, cause the electronic device to:
determine, based on a difference between a color value of the content in the second window and a color value of the content corresponding to the input being equal to or greater than a set value, the transparency of the second window as a first transparency; and
determine, based on the difference between the color value of the content of the second window and the color value of the content corresponding to the input being less than the set value, the transparency of the second window as a second transparency higher than the first transparency.

5. The electronic device of claim 1,
wherein the instructions, when executed by at least one processor individually or collectively, cause the electronic device to maintain the increased transparency of the second window for a set time period after the input is completed.

6. The electronic device of claim 5,
wherein the instructions, when executed by at least one processor individually or collectively, cause the electronic device to change, based on the expiration of the set time period after the input is completed, the transparency of the second window to an original transparency so that the content corresponding to the input received in the second area is not displayed.

7. The electronic device of claim 1,
wherein the instructions, when executed by at least one processor individually or collectively, cause the electronic device to:
identify, based on a second input being received in the second area within a set time after the input is completed, the second input as an input for the first window; and
maintain the increased transparency of the second window.

8. The electronic device of claim 1,
wherein the instructions, when executed by at least one processor individually or collectively, cause the electronic device to:
identify, based on a second input being received within a set distance based on a location where the input is completed after the input is completed, the second input as an input for the first window; and
maintain the increased transparency of the second window.

9. The electronic device of claim 1,
wherein the instructions, when executed by at least one processor individually or collectively, cause the electronic device to:
generate content corresponding to a received input in the second area, as an upper layer on the second window; and
display the content corresponding to the received input in the second area, overlapping the second window.

10. The electronic device of claim 1,
wherein the input includes at least one of a drawing input or a text input.

11. A method of controlling an electronic device, the method comprising:
displaying, through a touch screen of the electronic device, a first window as a lower layer and a second window as an upper layer at least partially overlapping the first window;
receiving an input through a first area, not overlapping the second window, of the first window; and
increasing, based on detecting that the input continuously moves from the first area to a second area where the first window is overlapped with the second window, transparency of the second window.

12. The method of claim 11,
wherein the increasing of the transparency of the second window comprises:
determining the transparency of the second window, based on at least one of an amount of content of the second window, a color of the content of the second window, a color of content corresponding to the input, and/or a thickness of the content corresponding to the input.

13. The method of an electronic device of claim 12,
wherein the increasing of the transparency of the second window comprises:
determining, based on the amount of the content of the second window being less than a set value, the transparency of the second window to be a first transparency; and
determining, based on the amount of the content of the second window being greater than or equal to the set value, the transparency of the second window to be a second transparency higher than the first transparency.

14. The method of an electronic device of claim 12,
wherein the increasing of the transparency of the second window comprises:
determining, based on a difference between a color value of the content of the second window and a color value of the content corresponding to the input being equal to or greater than a set value, the transparency of the second window to be a first transparency; and
determining, based on the difference between the color value of the content of the second window and the color value of the content corresponding to the input being less than the set value, the transparency of the second window to be a second transparency higher than the first transparency.

15. The method of an electronic device of claim 11,
further comprising maintaining the increased transparency of the second window for a set time period after the input is completed.

16. The method of an electronic device of claim 15,
further comprising changing, based on the expiration of the set time period after the input is completed, the transparency of the second window to an original transparency so that the content corresponding to the input received in the second area is not displayed.

17. The method of an electronic device of claim 11,
further comprising identifying, based on a second input being received in the second area within a set time after the input is completed, the second input as an input for the first window; and
maintaining the increased transparency of the second window.

18. The method of an electronic device of claim 11,
further comprising identifying, based on a second input being received within a set distance based on a location where the input is completed after the input is completed, the second input as an input for the first window; and
maintaining the increased transparency of the second window.

19. The method of an electronic device of claim 11,
further comprising generating content corresponding to a received input in the second area, as an upper layer on the second window; and
displaying the content corresponding to the received input in the second area, overlapping the second window.

20. A non-transitory computer-readable medium storing computer-executable instructions, wherein the computer-executable instructions, when executed by at least one processor of an electronic device individually or collectively, cause the electronic device to:
display, through the touch screen, a first window as a lower layer and a second window as an upper layer at least partially overlapping the first window;
receive an input through a first area, not overlapping the second window, of the first window; and
increase, based on detecting that the input continuously moves from the first area to a second area where the first window is overlapped with the second window, a transparency of the second window.
